(19) United States
(12) Patent Application Publication
(10) Pub. No.: US 2009/0225342 A1
(43) Pub. Date: Sep. 10, 2009

(54) IMAGE FORMING APPARATUS

(75) Inventor: Masato Ogasawara, Tokyo (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/400,040

(22) Filed: Mar. 9, 2009

Related U.S. Application Data
(60) Provisional application No. 61/035,212, filed on Mar. 10, 2008.

(51) Int. Cl. H04N 1/60

(52) U.S. Cl. 358/1.9

(57) ABSTRACT

When image adjustment is performed, patterns are formed under an image formation condition within a range in which a problem does not occur in registration adjustment. Formed patterns are detected and the registration adjustment is performed. After the registration adjustment is performed and the charge amount of a developer becomes stable, image quality adjustment for the time of image formation is performed.

### CROSS-REFERENCE TO RELATED APPLICATION

This application is based upon and claims the benefit of priority from Provisional U.S. Application 61/035,212 filed on Mar. 10, 2008, the entire contents of which are incorporated herein by reference.

### TECHNICAL FIELD

The present invention relates to an image forming apparatus for performing registration adjustment of an image and image quality adjustment in a color copy machine or a multi-function peripheral.

### BACKGROUND

In a color image, image adjustment is performed to maintain the image quality. In the image adjustment, registration adjustment to adjust a positional relation of plural images, and image quality adjustment of the plural images are performed. There is an image forming apparatus in which for the image adjustment, the registration adjustment is performed after density adjustment of an image is performed.

In order to perform stable density adjustment, it is necessary to sufficiently agitate a developer and to stabilize the charge amount of the developer. In order to perform the stable density adjustment, it takes a time to sufficiently agitate the developer. When the registration adjustment is performed after the density adjustment is performed at the time of the image adjustment, since it takes a time to perform the density adjustment, there is a fear that the waiting time of a user until the image adjustment is ended becomes long.

It is desired to develop an image forming apparatus in which the waiting time of the user until the image adjustment is ended is shortened, and the image forming speed is increased.

### SUMMARY

In an aspect of the invention, registration adjustment and image quality adjustment of a color image are performed without requiring a long waiting time, and the image forming speed is increased.

According to an aspect, an image forming apparatus includes a latent image forming member to form an electrostatic latent image on each of plural image carriers, plural developing members to develop the electrostatic latent images formed on the plural image carriers and to form plural toner images, a transfer member to transfer the plural toner images formed on the plural image carriers, and a control member that detects positions of the plural toner images transferred to a transfer medium, causes a registration mode of performing registration adjustment of the respective toner images and an image quality maintaining mode of performing image quality adjustment of the respective toner images to be selectively performed, and performs the registration mode before the image quality maintaining mode.

### DESCRIPTION OF THE DRAWINGS

FIG. 1 is a schematic structural view showing a copy machine of a first embodiment;

FIG. 2 is a schematic explanatory view showing sensors in the first embodiment;

FIG. 3 is a block diagram showing a control system in the first embodiment;

FIG. 4 is a table showing an environmental characteristic of a developing device stored in a memory in the first embodiment;

FIG. 5 is a graph showing an aging characteristic of the developing device stored in the memory in the first embodiment;

FIG. 6 is a graph showing an environmental characteristic of a photoconductive drum stored in the memory in the first embodiment;

FIG. 7 is a graph showing an aging characteristic of laser light amount stored in the memory in the first embodiment;

FIG. 8 is a table showing an environmental coefficient of development contrast stored in the memory in the first embodiment;

FIG. 9 is a flowchart showing image adjustment in the first embodiment;

FIG. 10 is a schematic explanatory view showing patterns printed on a transfer belt in the first embodiment;

FIG. 11 is an explanatory view for setting an adjustment value of image inclination from the patterns in the first embodiment;

FIG. 12 is an explanatory view sowing an inclination shift on a photoconductive drum in the first embodiment;

FIG. 13A is an explanatory view showing a toner image with an inclination shift in the first embodiment;

FIG. 13B is an explanatory view showing adjustment of a tilt mirror in the first embodiment;

FIG. 14 is an explanatory view for setting an adjustment value of a position shift in a sub-scanning direction from the patterns in the first embodiment;

FIG. 15 is an explanatory view showing a sub-scanning position shift on the photoconductive drum in the first embodiment;

FIG. 16 is an explanatory view showing a toner image with a sub-scanning position shift in the first embodiment;

FIG. 17 is an explanatory view for setting an adjustment value of a position shift in a main scanning direction from the patterns in the first embodiment of the invention;

FIG. 18 is an explanatory view showing a main scanning position shift on the photoconductive drum in the first embodiment;

FIG. 19 is an explanatory view showing a toner image with a main scanning position shift in the first embodiment;

FIG. 20 is an explanatory view for setting an adjustment value of a main scanning magnification shift from the patterns in the first embodiment of the invention;

FIG. 21 is an explanatory view showing a main scanning magnification shift on the photoconductive drum in the first embodiment;

FIG. 22 is an explanatory view showing a toner image with a main scanning magnification shift in the first embodiment;

FIG. 23 is an explanatory view showing patches of density detection in the first embodiment;

FIG. 24 is an explanatory view showing a relation between an image density and a detected value of a density sensor in the first embodiment;

FIG. 25 is an explanatory view showing a relation between the charge amount of a developer and image adjustment in the first embodiment;

FIG. 26 is a schematic structural view showing a main part of a color copy machine of a first modified example;

FIG. 27 is a schematic perspective view showing the main part of the color copy machine of the first modified example;

FIG. 28 is a schematic structural view showing a main part of a color copy machine of a second modified example;

FIG. 29 is a schematic structural view showing a main part of a color copy machine of a third modified example; and

FIG. 30 is a schematic structural view showing a main part of a color copy machine of a fourth modified example.

### DETAILED DESCRIPTION

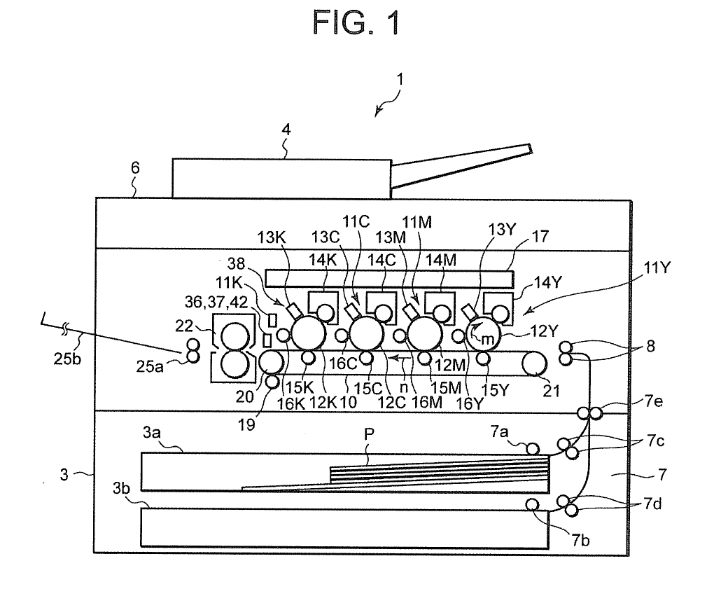

Hereinafter, a first embodiment will be described. FIG. 1 is a schematic structural view of a color copy machine 1 of train-of-four tandem system as an image forming apparatus of the first embodiment. The color copy machine 1 includes a scanner unit 6 to read an original document supplied by an auto document feeder 4. The color copy machine 1 includes four sets of image forming stations 11Y, 11M, 11C and 11K of yellow (Y), magenta (M), cyan (C) and black (K) disposed in parallel along a transfer belt 10.

The respective image forming stations 11Y, 11M, 11C and 11K include photoconductive drums 12Y, 12M, 12C and 12K as image carriers. A rotation shaft of each of the photoconductive drums 12Y, 12M, 12C and 12K is parallel to a main scanning direction. The main scanning direction is orthogonal to a traveling direction of an arrow n direction of the transfer belt 10 (sub-scanning direction). The respective rotation shafts of the photoconductive drums 12Y, 12M, 12C and 12K are disposed to be spaced from each other at equal intervals in the sub-scanning direction.

Charging chargers 13Y, 13M, 13C and 13K, developing devices 14Y, 14M, 14C and 14K as developing members, and photoconductive cleaners 16Y, 16M, 16C and 16K are respectively disposed around the photoconductive drums 12Y, 12M, 12C and 12K along the rotation direction of an arrow m direction. The developing devices 14Y, 14M, 14C and 14K respectively include developers of different colors of yellow (Y), magenta (M), cyan (C) and black (K). The developing devices 14Y, 14M, 14C and 14K develop electrostatic latent images on the photoconductive drums 12Y, 12M, 12C and 12K to form toner images of the respective colors on the respective photoconductive drums 12Y, 12M, 12C and 12K.

A laser exposure device 17 as a latent image forming member irradiates respective laser exposure beams to the photoconductive drums 12Y, 12M, 12C and 12K. The respective laser exposure beams are based on data of the respective color components of the image data. The laser exposure device 17 forms the respective electrostatic latent image on the photoconductive drums 12Y, 12M, 12C and 12K.

The transfer belt 10 is supported by a drive roller 20 and a driven roller 21, and is rotated in the arrow n direction. The toner images formed on the photoconductive drums 12Y, 12M, 12C and 12K are transferred to a sheet P as a recording medium conveyed in the arrow n direction by the transfer belt 10 at positions of transfer rollers 15Y, 15M, 15C and 15K. A color toner image is formed on the sheet P conveyed by the transfer belt 10. The transfer belt 10 and the transfer rollers 15Y, 15M, 15C and 15K constitute a transfer member.

The sheet P is fed from a cassette mechanism 3 including first and second paper feed cassettes 3a and 3b to the transfer belt 10 through a conveying unit 7. The conveying unit 7 includes pickup rollers 7a and 7b to pick up a sheet from the paper feed cassettes 3a and 3b, separation conveying rollers 7c and 7d, a conveying roller 7e and a registration roller 8. The color toner image formed on the sheet P is fixed by a fixing device 22 and a color image is completed, and then, the sheet is ejected through a paper discharge roller 25a to a storage tray 25b. After the transfer is ended, residual toners on the photoconductive drums 12Y, 12M, 12C and 12K are cleaned by the photoconductive cleaners 16Y, 16M, 16C and 16K, and next printing becomes possible.

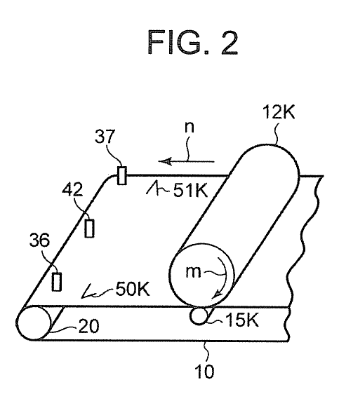

As shown in FIG. 2, first and second pattern sensors 36 and 37 are provided downstream of the image forming station 11K of black (K) of the transfer belt 10. A density sensor 42 is provided at an intermediate position between the first and the second pattern sensors 36 and 37. The first and the second pattern sensors 36 and 37 are used for registration. The density sensor 42 is used for image quality adjustment. The first and the second pattern sensors 36 and 37 perform position detection of registration patterns formed on the transfer belt 10 at the time of a registration mode. The first and the second pattern sensors 36 and 37 are disposed to be spaced from each other by a specified distance in the main scanning direction. A temperature and humidity sensor 38 for detecting an environment in a main body of the color copy machine 1 is provided above the density sensor 42.

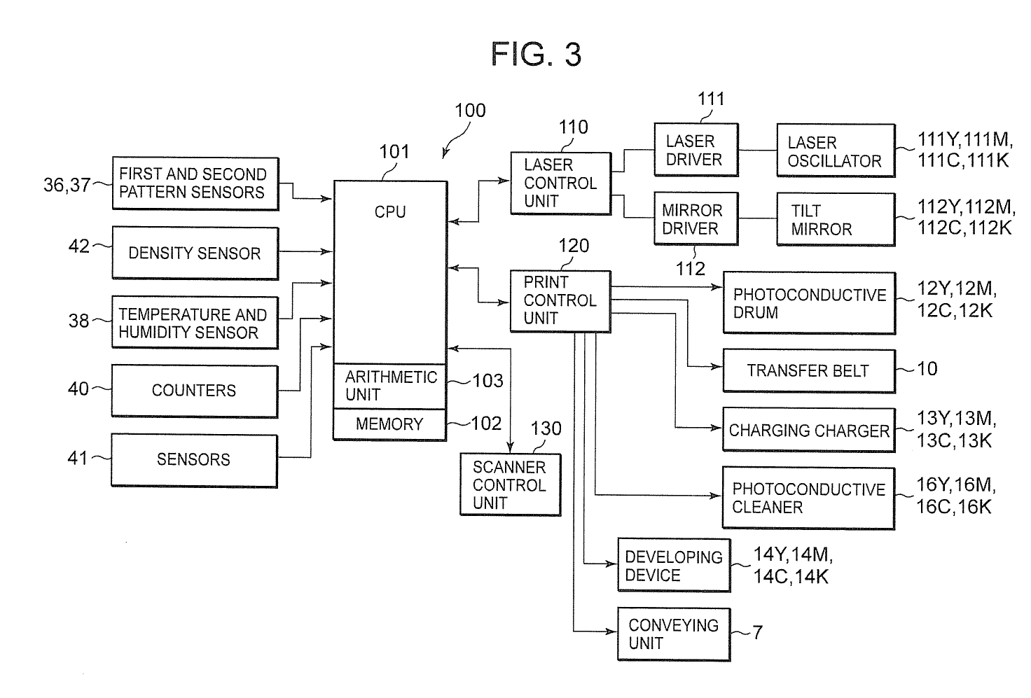

FIG. 3 is a block diagram showing a control system 100 as a control member mainly relating to image adjustment. In the image adjustment, registration adjustment of an image and image quality adjustment are performed. The first and the second pattern sensors 36 and 37, the density sensor 42, and the temperature and humidity sensor 38 are connected to the input side of a CPU 101 of the control system 100, which controls the whole color copy machine 1. Counters 40 to count the number of rotations of each of the photoconductive drums 12Y, 12M, 12C and 12K of the respective color components and the number of rotations of each of developing rollers of the developing devices 14Y, 14M, 14C and 14K of the respective color components are connected to the input side of the CPU 101. Other sensors 41 necessary for the image formation are connected to the input side of the CPU 101.

The CPU 101 is connected to a laser control unit 110 and a print control unit 120 through an input and output interface. The CPU 101 is connected to a scanner control unit 130 to control the auto document feeder 4 and the scanner unit 6.

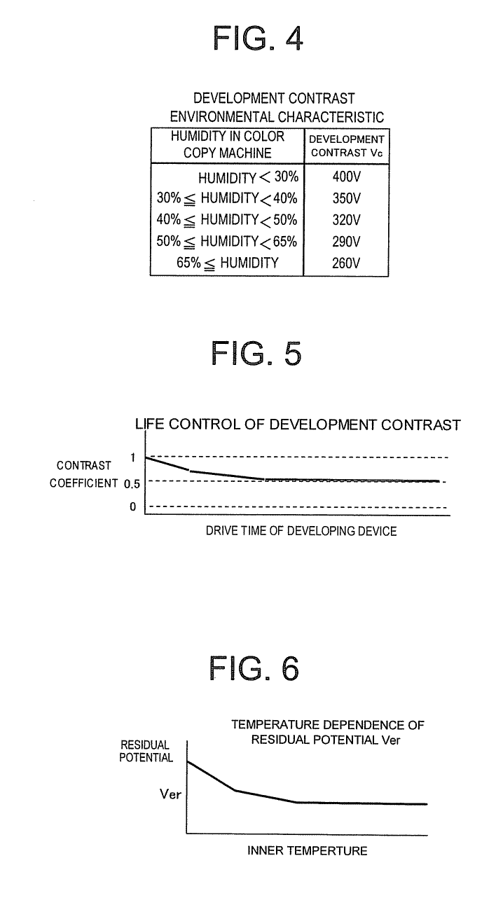

The CPU 101 includes a memory 102 to store various settings for controlling the laser control unit 110 and the print control unit 120. The memory 102 stores, for example, a table of an environmental characteristic of each of the developing devices 14Y, 14M, 14C and 14K shown in FIG. 4. The table of the environmental characteristic of each of the developing devices 14Y, 14M, 14C and 14K represents a development contrast Vc with respect to the inside humidity of the color copy machine 1.

The memory 102 stores, for example, a graph of an aging characteristic of each of the developing devices 14Y, 14M, 14C and 14K shown in FIG. 5. FIG. 5 shows a contrast coefficient with respect to the drive time of each of the developing devices 14Y, 14M, 14C and 14K (that is, the number of rotations of the developing roller). The contrast coefficient is used for adjustment of a variation of the development contrast (life control).

The memory 102 stores, for example, a graph of an environmental characteristic of each of the photoconductive drums 12Y, 12M, 12C and 12K shown in FIG. 6. The graph of the environmental characteristic of each of the photoconductive drums 12Y, 12M, 12C and 12K represents a variation of a residual potential Ver of each of the photoconductive drums 12Y, 12M, 12C and 12K with respect to the inside temperature of the color copy machine 1.

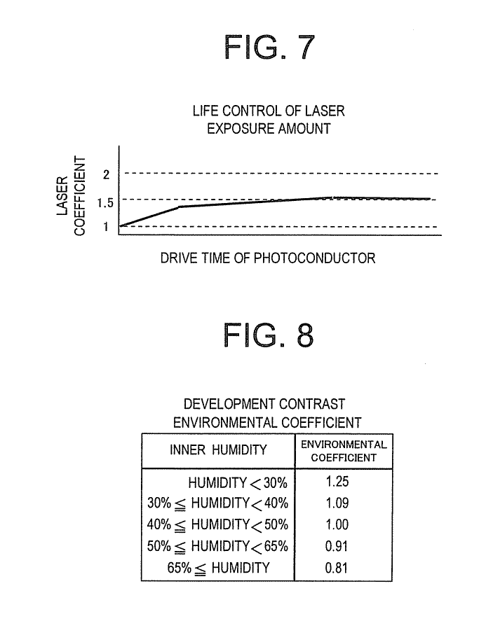

The memory 102 stores, for example, life control of a laser light amount with respect to the drive time of each of the photoconductive drums 12Y, 12M, 12C and 12K shown in FIG. 7. FIG. 7 shows a laser coefficient to adjust the laser light amount with respect to the drive time of each of the photoconductive drums 12Y, 12M, 12C and 12K (that is, the number of rotations of the photoconductive drum). The laser coefficient is used to adjust the variation of the development contrast.

The memory 102 stores, for example, a development bias of each of the developing devices 14Y, 14M, 14C and 14K and a laser light amount of each of the color components of the laser exposure device 17, which are prior density adjustment values at the time of the image formation performed just before.

The memory 102 stores, for example, an environmental coefficient based on a humidity change of a development bias of each of the developing devices 14Y, 14M, 14C and 14K shown in FIG. 8.

The CPU 101 includes an arithmetic unit 103 to calculate an adjustment value of the registration adjustment and an adjustment value of the image quality adjustment by using the laser control unit 110 and the print control unit 120. In the registration adjustment and the image quality adjustment, the adjustment values are calculated by using the detection results of the registration patterns formed on the transfer belt 10. The laser control section 110 adjusts the laser exposure device 17 based on the adjustment values obtained by the calculation. The print control unit 120 adjusts the developing devices 14Y, 14M, 14C and 14K based on the adjustment values.

The laser control unit 110 includes a laser driver 111 to adjust writing timings of laser oscillators 111Y, 111M, 111C and 111K of the respective color components or laser light amounts of the respective color components. The laser control unit 110 includes a mirror driver 112 to adjust angles of tilt mirrors 112Y, 112M, 112C and 112K of the respective color components.

The print control unit 120 controls the photoconductive drums 12Y, 12M, 12C and 12K, the transfer belt 10, the charging chargers 13Y, 13M, 13C and 13K, the developing devices 14Y, 14M, 14C and 14K, the photoconductive cleaners 16Y, 16M, 16C and 16K, and the conveying unit 7. The print control unit 120 adjusts the developing biases of the developing devices 14Y, 14M, 14C and 14K.

The first and the second pattern sensors 36 and 37, the laser control unit 110 and the print control unit 120 are used for the registration adjustment. The density sensor 42, the laser control unit 110 and the print control unit 120 are used for the image quality adjustment.

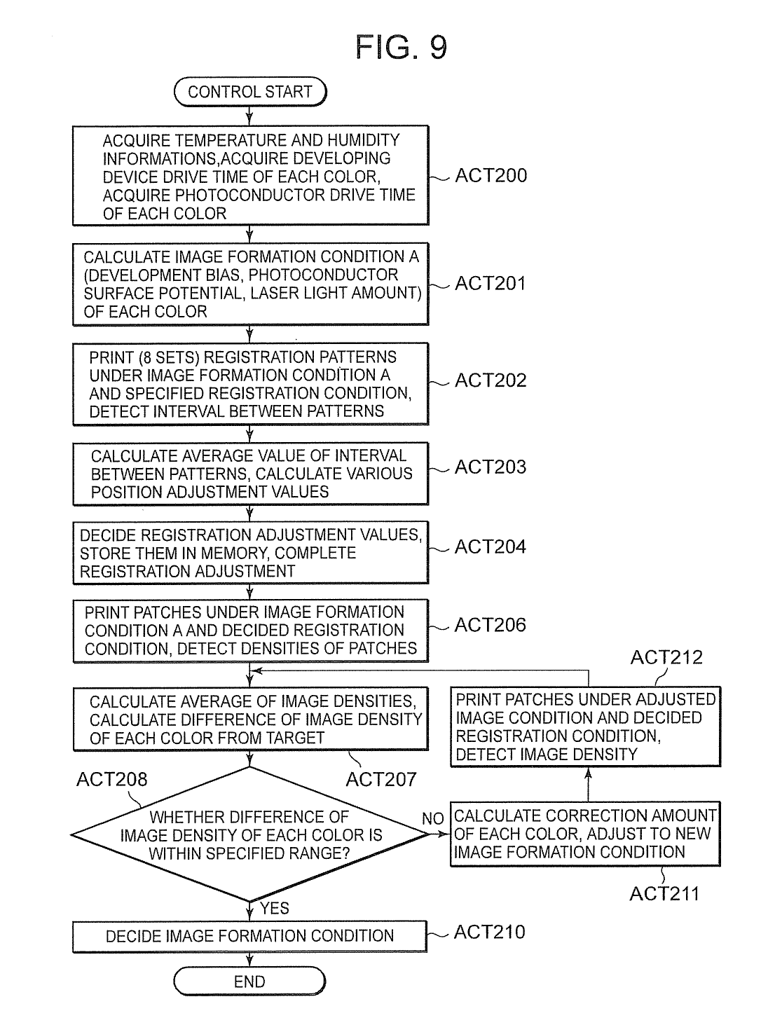

For example, when power is turned ON, the color copy machine 1 starts the image adjustment shown in a flowchart of FIG. 9. In the image adjustment, the registration mode for performing the registration adjustment of plural toner images, and the image quality maintaining mode for performing the image quality adjustment of plural toner images are performed.

The color copy machine 1 forms a color image by superimposing toner images of four colors of Y, M, C and K. In the color image, the color balance is lost when for example, image density of merely one color of the four colors of Y, M, C and K is shifted. Fine image quality adjustment is required for all of the four colors of Y, M, C and K. In the color copy machine 1, when the superimposing positions of toner images of the four colors (Y, M, C and K) are shifted, the color image becomes blurring. The registration adjustment to correct the shift of the toner images of the respective colors is required. Next, the outline of the image quality adjustment and the registration adjustment of the color image will be described.

### (I) Outline of the Image Quality Adjustment of the Image;

(A) In the color image forming apparatus, the charging device applies electric charge and the photoconductor is charged to a surface potential V0. When exposure light is irradiated according to image information, an electrostatic latent image with residual potential Ver is formed on the photoconductor. Toner is supplied to the portion of the residual potential Ver by the developing device to develop the electrostatic latent image. When the development bias Vb is applied to the developing device, the toner adhesion amount of the photoconductor is changed according to the value of |Vb−Ver|. (|Vb−Ver| is called development contrast Vc.)

(B) (a) The charge amount of a developer is changed according to the humidity. There is a tendency that when the humidity is changed to a low humidity side, the image density becomes low, and when the humidity is changed to a high humidity side, the image density becomes high. In order to put the image density within a specified range, it is necessary that when the humidity is changed to the low humidity side, the development contrast Vc is set to be large, and when the humidity is changed to the high humidity side, the development contrast Vc is set to be low.

(b) The charge amount of the developer is changed according to the drive time (aging change occurs). As the drive time of the developing device elapses, the charge amount of the developer is lowered, and there is a tendency that the image density becomes high when the development contrast is the same as the initial one. In order to put the image density within the specified range, it is necessary that the development contrast Vc is set to become gradually low according to the temporal change.

(c) When |V0−Vb| of the developing device (|V0−Vb| is called background potential Vbg) is set to be low, there occurs fogging in which unnecessary toner is adhered to the white background of the photoconductor. When |V0−Vb| is set to be high, the carrier of the developer adheres to the photoconductor, and the developer is gradually decreased. It is necessary to set |V0−Vb|=Vbg within a suitable range.

(d) The electrostatic characteristic of the photoconductor is changed by temperature. When the temperature is changed to a low temperature side, the residual potential Ver rises. Even if the exposure amount is raised, the residual potential Ver hardly changes.

As in (b) to (d), the image quality is changed by the environmental characteristics and the aging characteristics. It is preferable to perform the image quality adjustment periodically. Like the case where the power of the image forming apparatus is turned ON in morning, when printing is started after the image forming apparatus is left for a long time, there is a high-possibility that the environmental characteristics are significantly changed, and the image quality adjustment of the toner image is especially desired.

### (II) Outline of the Registration Adjustment of the Image

In the color image forming apparatus, for example, the temperature in the machine body when power is turned ON in morning is close to the room temperature (significantly different from the temperature in the machine body during print operation). In the optical system of the laser exposure device, a variation characteristic occurs by a variation in the temperature in the machine body of the color image forming apparatus. When the characteristics of the optical system vary, a position shift relatively occurs among the toner images of the four colors. The image registration adjustment corrects the position shift of toner images caused by the environmental characteristics.

In this embodiment, as the image adjustment, the image registration adjustment is performed, and then, the image quality adjustment is performed. In the image registration adjustment, patterns as pattern toner images written on the transfer belt 10 are detected, and the writing position of the pattern is adjusted.

An image density in an image formation condition when the patterns are written is made a registration density. The registration density is set separately from an image density in an image formation condition at the time of normal image formation (at the time of image formation mode). It is necessary that the registration density is suitably set. For example, when the same image patterns are formed, when the image density of the image pattern becomes low, the line width of the obtained image pattern becomes thin as compared with the case where the image density is high. When the patterns are written on the transfer belt 10, when the image density is not stabilized, variation occurs in the line widths of the obtained patterns. When the line width of the pattern varies, an error occurs in the registration adjustment. Thus, the registration density is made the density within the range where a problem does not occur in the registration adjustment. That is, the registration density may not fall within the target range of the image density for image formation.

The registration density is determined based on, for example,

(1) the environmental characteristics and aging characteristics of the color copy machine 1.

The registration density is determined based on, for example,

(2) the immediately prior density adjustment value.

In FIG. 9, the patterns are written on the transfer belt 10 by using the registration density determined based on the environmental characteristics and the aging characteristics of the color copy machine 1 of (1). The detection result of the temperature and humidity sensor 38 is acquired by the image adjustment start. The drive times of the developing rollers of the respective developing devices 14Y, 14M, 14C and 14K are acquired from the count results of the counters 40. The drive times of the respective photoconductive drums 12Y, 12M, 12C and 12K are acquired (Act 200).

An image formation condition A (development bias, photoconductor surface potential, laser light amount), as density adjustment values, is calculated which is for obtaining the registration density when the patterns of the respective color components are written on the transfer belt 10 (Act 201). At Act 201, the development contrast Vc is obtained by referring to FIG. 4 from the humidity classification of the color copy machine 1 acquired at Act 200. The contrast coefficient is obtained by referring to FIG. 5 from the drive time of the developing roller acquired at Act 200. The desired development contrast Vc is obtained by multiplying the development contrast Vc obtained by referring to FIG. 4 by the contrast coefficient obtained by referring to FIG. 5. The desired development contrast Vc obtained by multiplying the contrast coefficient is made the value for the registration density and the development contrast Vc used when the pattern is first printed. For example, when the humidity in the main body of the color copy machine 1 is 45% RH and the drive time of the developing roller is close to the life end, the development contrast becomes Vc=320×0.5=160 (V).

At Act 201, the residual potential Ver is determined by referring to FIG. 6 from the temperature of the color copy machine 1 acquired at Act 200. The laser coefficient is obtained by referring to FIG. 7 from the number of rotations of the photoconductive drum acquired at Act 200. The laser light amount Lp is determined by multiplying the initial laser light amount Lp (ini) by the laser coefficient obtained by referring to FIG. 7. The photoconductor surface potential V0 is obtained by adding the development contrast Vc and the background potential Vbg (The background potential Vbg is fixed value. For example, the background potential Vbg is 120 V) to the residual potential Ver. That is, the photoconductor surface potential is V0=Ver+Vc+Vbg.

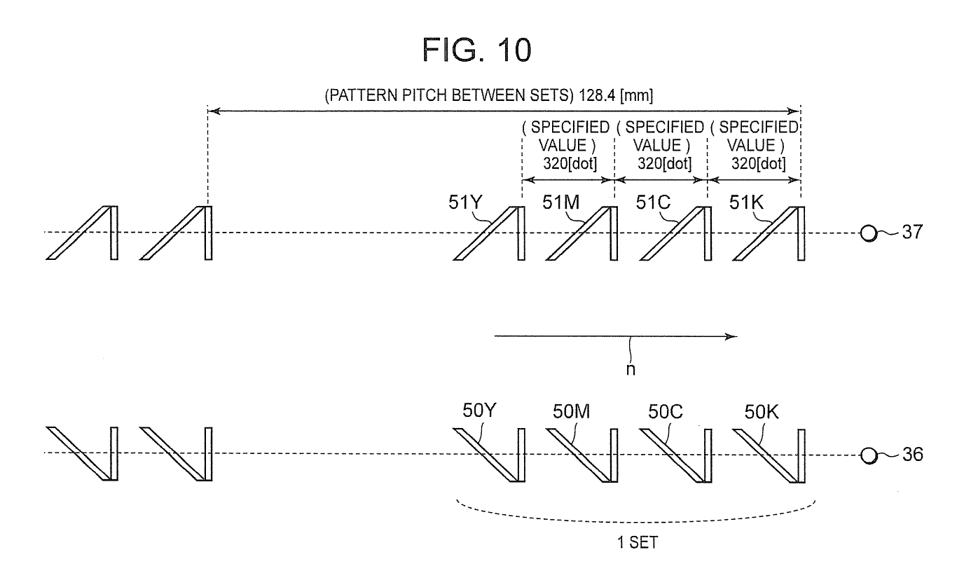

The patterns of the specified condition are printed on the transfer belt 10 under the image formation condition A (development bias Vb, photoconductor surface potential V0, laser light amount Lp) calculated at Act 201. The interval between the printed patterns is detected (Act 202). At Act 202, as shown in FIG. 10, the wedge-shaped patterns of the four colors of Y, M, C and K are printed on the transfer belt 10. The four colors of Y, M, C and K are made one set, and eight sets of front side patterns 50Y, 50M, 50C and 50K and eight sets of rear side patterns 51Y, 51M, 51C and 51K are printed on the transfer belt 10.

At Act 202, each of the intervals between Y-M, M-C and C-K of the patterns is made an interval of 320 [dot] of a specified value. The pattern pitch between the sets is made a specified value of 128.4 [mm]. The interval of the front side patterns 50Y, 50M, 50C and 50K is measured plural times by the front side first pattern sensor 36. The interval of the rear side patterns 51Y, 51M, 51C and 51K is measured plural times by the rear side second pattern sensor 37.

The adjustment value of the registration adjustment is calculated from the average value of the intervals of the patterns measured at Act 202 (Act 203). The arithmetic unit 103 sets the adjustment value based on the measurement result. The setting of the adjustment value is well known (see, for example, JP-A-8-278680), and various well-known methods can be adopted.

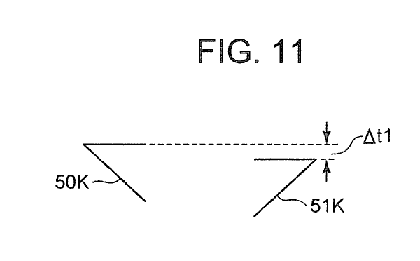

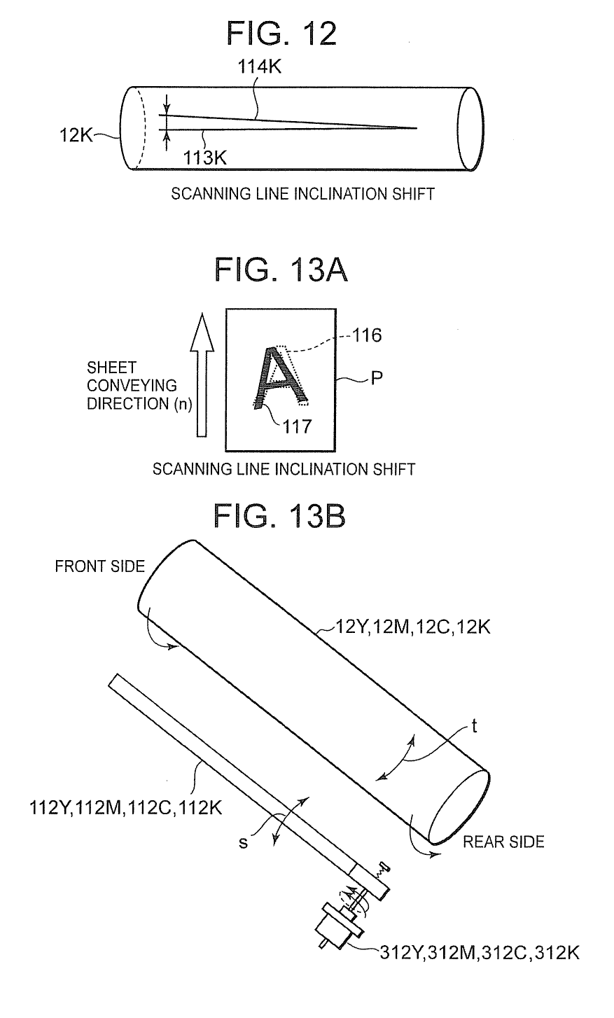

For example, as shown in FIG. 11, it is assumed that the output timing of the front side pattern 50K of black (K) is shifted from that of the rear side pattern 51K by Δt1. As shown in FIG. 12, the arithmetic unit 103 determines that an axis 113K of the photoconductive drum 12K of black (K) is inclined with respect to the scanning direction of a laser beam 114K of the laser oscillator 111K of black (K). When image formation is performed without adjustment, as shown in FIG. 13A, a black toner image formed on the sheet P becomes an inclined shift toner image 117 indicated by a solid line with respect to an appropriate position 116 indicated by a chain line. In order to adjust the inclination, the arithmetic unit 103 sets the inclination amounts of the tilt mirrors 112Y, 112M, 112C and 112K as the adjustment values according to the inclination amount. As shown in FIG. 13B, tilt motors 312Y, 312M, 312C and 312K are driven by the mirror driver 112 as the need arises, and the inclinations of the tilt mirrors 112Y, 112M, 112C and 112K are adjusted in an arrow direction. Respective scanning lines 114Y, 114M, 114C and 114K are shifted in an arrow t direction and the inclination is adjusted.

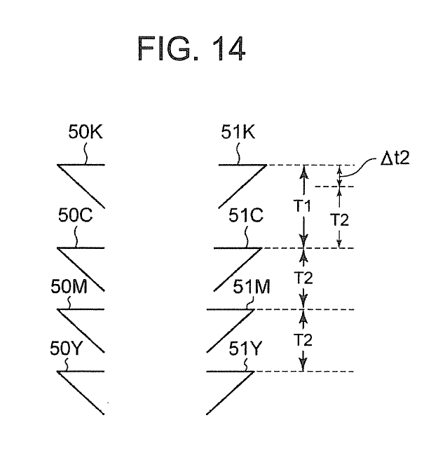

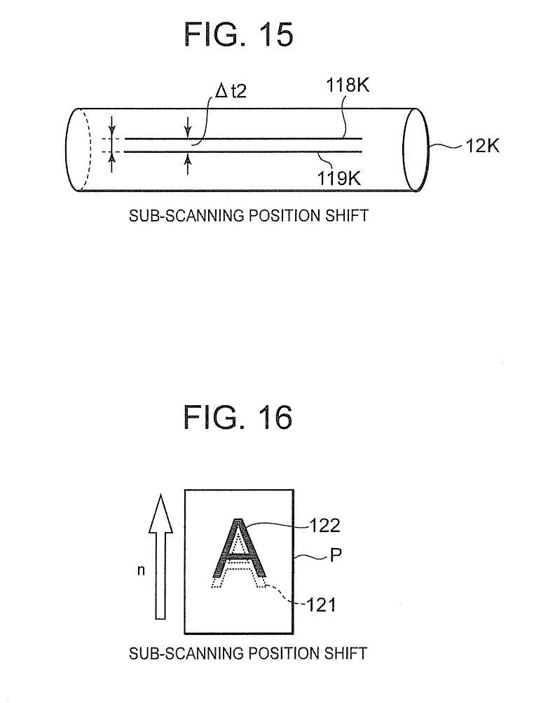

For example, as shown in FIG. 14, it is assumed that the interval T1 between the pattern 50C, 51C of cyan (C) and the pattern 50K, 51K of black (K) is shifted from the interval T2 between other patterns. As shown in FIG. 15, the arithmetic unit 103 determines that a position 118K of the pattern 50K, 51K of black (K) is shifted in the sub-scanning direction by Δt2 as the difference between the interval T1 and the interval T2 with respect to an original position 119K. When the image formation is performed without adjustment, as shown in FIG. 16, the black toner image formed on the sheet P becomes a sub-scanning position shift toner image 122 indicated by a solid line with respect to an appropriate position 121 indicated by a chain line.

In order to adjust the shift in the sub-scanning direction, the arithmetic unit 103 sets the difference between output timings of the image data corresponding to Δt2 as the adjustment value. The laser control unit 110 adjusts the delay amount between the drums. Incidentally, the adjustment value obtained by combining the inclination amount in FIG. 11 and the shift amount of the pattern interval in the sub-scanning direction in FIG. 14 may be set as the adjustment value.

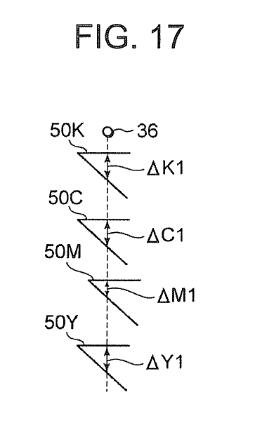

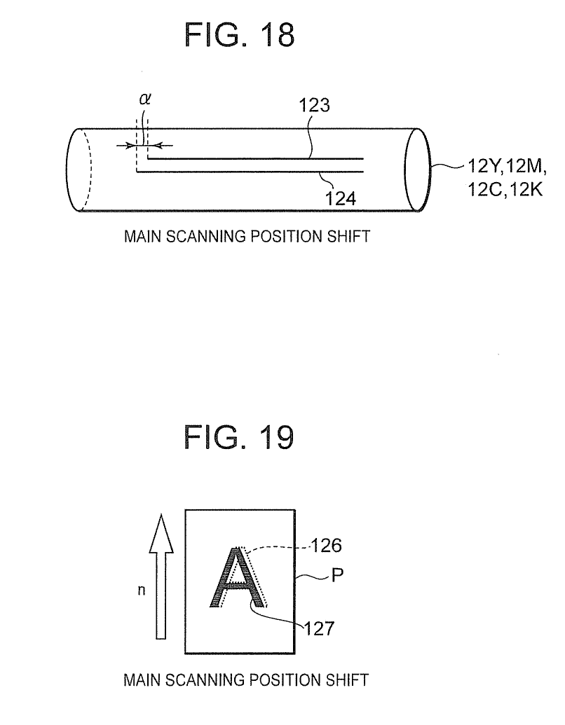

For example, as shown in FIG. 17, it is assumed that detection lengths ΔK1, ΔC1, ΔM1 and ΔY1 of the front side patterns 50Y, 50M, 50C and 50K are shifted from each other. As shown in FIG. 18, the arithmetic unit 103 determines that a position of each color component 123 is shifted from an original position 124 in the main scanning direction by α. When the image formation is performed without adjustment, as shown in FIG. 19, a toner image formed on the sheet P becomes a main scanning position shift toner image 127 indicated by a solid line with respect to an appropriate position 126 indicated by a chain line. The amount of the position shift of the image in the main scanning direction is determined from the respective differences of the detection lengths ΔK1, ΔC1, ΔM1 and ΔY1.

The arithmetic unit 103 sets the shift amounts of image data corresponding to the detection lengths ΔK1, ΔC1, ΔM1 and ΔY1 as the adjustment values in order to adjust the shift in the main scanning direction. The adjustment values are set so as to establish ΔK1=ΔC1=ΔM1=ΔY1. The laser control unit 110 adjusts the timing of the start of main scanning printing-out.

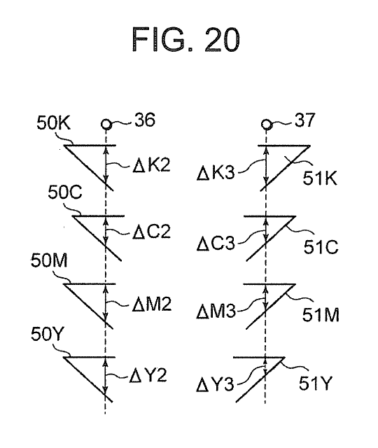

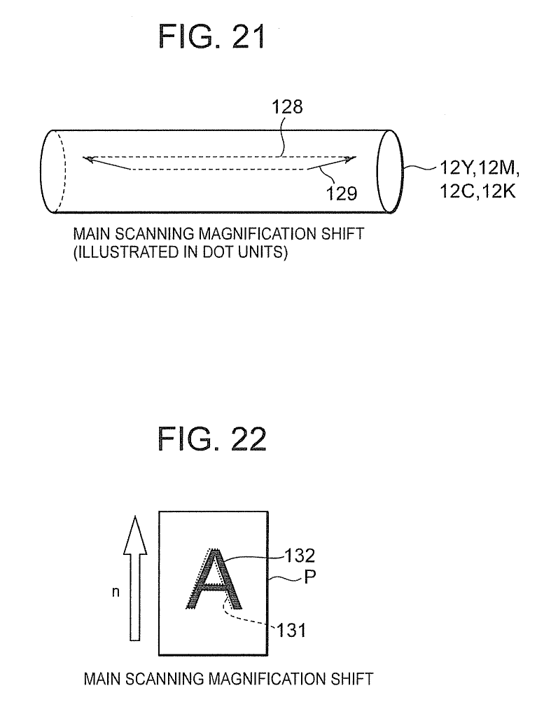

For example, as shown in FIG. 20, it is assumed that detection lengths ΔK2, ΔC2, ΔM2 and ΔY2 of the front side patterns 50Y, 50M, 50C and 50K of the respective color components and detection lengths ΔK3, ΔC3, ΔM3 and ΔY3 of the rear side patterns 51Y, 51M, 51C and 51K are respectively shifted. As shown in dot units in FIG. 21, the arithmetic unit 103 determines that the number of dots of each color component 128 is different from the number of dots of an original pattern 129, and a magnification shift occurs in the main scanning direction. When the image formation is performed without adjustment, as shown in FIG. 22, the toner image formed on the sheet P becomes a main scanning magnification shift toner image 132 indicated by a solid line with respect to an appropriate image 131 indicated by a chain line. With respect to the amount of the magnification shift of the image in the main scanning direction, the adjustment value is set from the value obtained by adding the front side detection lengths ΔK2, ΔC2, ΔM2 and ΔY2 of the respective color components and the rear side detection lengths ΔK3, ΔC3, ΔM3 and ΔY3. When (ΔK2+ΔK3)=(ΔC2+ΔC3)=(ΔM2+ΔM3)=(ΔY2+ΔY3) is established, it is determined that the image magnifications of the respective color components in the main scanning direction are constant.

In order to adjust the magnification shift in the main scanning direction, the arithmetic unit 103 sets the speed of an image clock as the adjustment value. The laser control unit 110 adjusts the magnifications of clock frequencies of the laser oscillators 111Y, 111M, 111C and 111K.

The respective adjustment values calculated at Act 203 are decided as the registration adjustment values (Act 204). The respective decided adjustment values are stored in the memory 102. The image registration adjustment is completed.

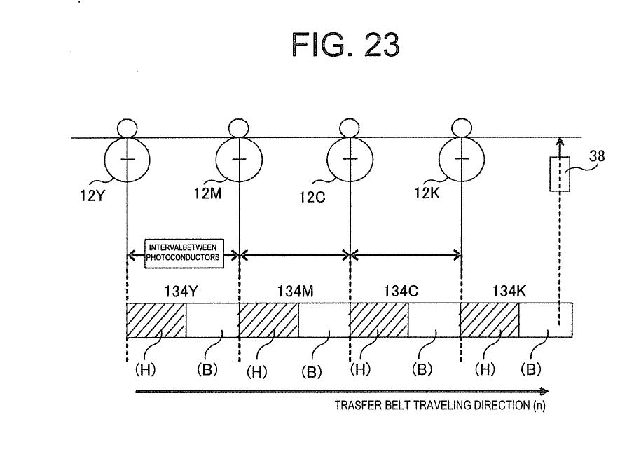

By the decided registration adjustment values, patch data for image quality adjustment is used, and patches as toner images for image quality are printed on the transfer belt 10. The patches are printed under the image formation condition A. The densities of the printed patches are detected (Act 206). As shown in FIG. 23, patches 134Y, 134M, 134C and 134K of the respective color components are printed on the transfer belt 10. With respect to the patches 134Y, 134M, 134C and 134K, printing is started simultaneously for all colors. When printing is performed by the length of the interval between the photoconductive drums 12Y, 12M, 12C and 12K, the printing is stopped simultaneously for all the colors. The patches 134Y, 134M, 134C and 134K of the four colors are arranged on the transfer belt 10 without gap. The patches 134Y, 134M, 134C and 134K of the four colors are made one set.

Each of the patches 134Y, 134M, 134C and 134K of the four colors include a solid patch (B) and a halftone patch (H) composed of specified pattern dots. The density sensor 42 detects the toner adhesion amount at 12 points for each of the solid patch (B) and the halftone patch (H)

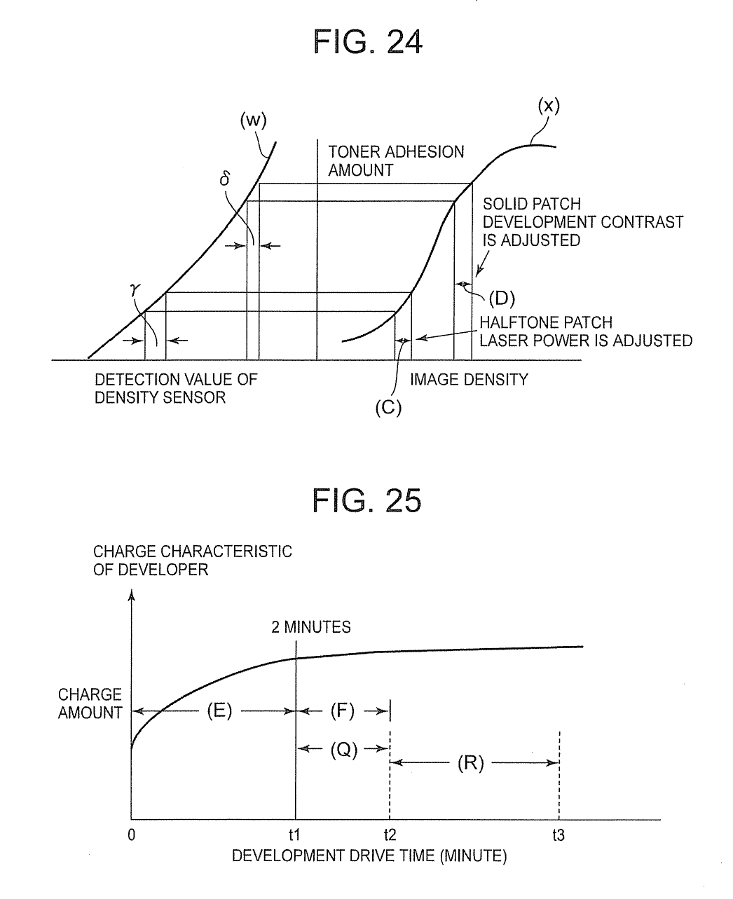

The arithmetic unit 103 calculates an average of the detection values of the density sensor 42 and decides a detection value of the density sensor 42. The arithmetic unit 103 calculates a difference between the target value of the image density of each color component and the decided detection value of the density sensor 42 (Act 207). FIG. 24 shows a relation among the detection value of the density sensor 42, the toner adhesion amount on the transfer belt 10, and the image density. A solid line (w) represents the detection value of the density sensor 42, and a solid line (x) represents the toner adhesion amount on the transfer belt 10. Reference is made to FIG. 24, and the range of the detection value of the density sensor 42 is determined according to the target range of the image density. For example, when the target range of the image density of the halftone patch (H) is (C), the range of the detection value of the density sensor 42 is determined to be (γ). When the target range of the image density of the solid patch (B) is (D), the range of the detection value of the density sensor 42 is determined to be (δ).

The CPU 101 determines from the calculation result of Act 207 whether a difference between the image densities of the respective color components is within a specified range (Act 208). When the difference between the image densities of the respective color components is within the specified range, advance is made to Act 210, and the image formation condition is decided. The image formation condition decided at Act 210 is decided as an image formation condition B at the time of the image formation. The image adjustment is ended.

When the difference between the image densities of the respective color components exceeds the specified range, advance is made to Act 211. At Act 211, the image formation condition is adjusted for each color component. The development contrast Vc is adjusted so that the image density of the solid patch (B) is within the target range. The laser light amount Lp is adjusted so that the image density of the halftone patch (H) is within the target range. From a difference from the range (δ) of the detection value calculated in the arithmetic unit 103, the print control unit 120 adjusts the development bias so that the image density of the solid patch (B) is within the target range (range (δ) of the detection value). The laser driver 111 adjusts the laser light amount Lp so that the image density of the halftone patch (H) falls within the target range (range (γ) of the detection value). The image density is adjusted at the two points of the solid patch (B) and the halftone patch (H) and the image density is more finely adjusted.

The solid patch (B) and the halftone patch (H) are printed on the transfer belt 10 by using the patch data for density detection under the image formation condition adjusted at Act 211. The density of the printed pattern is detected (Act 212). Advance is made to Act 207, the average of the detection values of the density sensor 42 is calculated, and the detection value of the density sensor 42 is decided. The arithmetic unit 103 calculates a difference between the target value of the image density of each color component and the decided detection value of the density sensor 42. At Act 208, when the difference between the image densities of the respective color components is within the specified range, advance is made to Act 210, and the image formation condition B at the time of the image formation is decided. The decided image formation condition B is stored in the memory 102.

When the difference between the image densities of the respective color components exceeds the specified range (Act 211), Act 212, Act 207 and Act 208 are repeated. The development bias and the laser amount Lp are adjusted so that the output of the density sensor 42 falls within the target range.

In the color copy machine 1, when the image adjustment including the registration adjustment and the image quality adjustment is completed in accordance with the flowchart of FIG. 9, a belt cleaner 19 removes the patterns and the patches on the transfer belt 10. After the image adjustment is completed, the color copy machine 1 performs desired printing on the sheet P according to image data.

In the first embodiment, when the power of the color copy machine 1 is turned ON, the registration adjustment is started, and when the registration adjustment is completed, the image quality adjustment is performed. The developer of the developing devices 14Y, 14M, 14C and 14K of the color copy machine 1 exhibits a charge characteristic shown in FIG. 25 when the driving is started by power-on. In the developer of the developing devices 14Y, 14M, 14C and 14K, the charge amount does not become stable until, for example, two minutes pass from the power-on. When the density adjustment is performed before the charge amount of the developer becomes stable, a high-precision adjustment value can not be obtained. In the first embodiment, the registration adjustment is performed before two minutes pass after the power is turned ON, that is, during a period (E) in which the charge amount of the developer does not become stable. During the period (E) in which the registration adjustment is performed, the developing devices 14Y, 14M, 14C and 14K are driven, and the charge amount of the developer gradually becomes stable. The image quality adjustment is performed during a period (F) after the registration adjustment is completed and after the charge amount of the developer becomes stable. After the power is turned ON, the registration adjustment and the image quality adjustment are all completed at development drive time (t2).

For example, as image adjustment of a comparison example, it is assumed that when the power of the color copy machine 1 is turned ON, the density adjustment is started, and after the density adjustment is completed, the registration adjustment is performed. When the power of the color copy machine is turned ON, even if the density adjustment is started, the density adjustment does not become stable until the charge amount of the developer becomes stable. The substantial density adjustment is obtained after (t1) when the charge amount of the developer becomes stable. In the comparison example, the substantial density adjustment is performed in a period (Q) from (t1), and after the density adjustment is completed, the registration adjustment is performed during a period (R). In the image adjustment, after the power is turned ON, the registration adjustment and the density adjustment are all completed at development drive time (t3). In the first embodiment, after the power is turned ON, the density adjustment is completed at (t2). In the comparison example, after the power is turned ON, the density adjustment is completed at (t3).

The image adjustment uses, for example, the timing when the power of the color copy machine 1 is turned on, the timing when warm up is performed after a jam removal process, or the timing between the sheets P during printing of image data.

The registration adjustment of the image adjustment may not be performed when the power is turned ON immediately after the power of the color copy machine 1 is turned OFF (the temperature in the machine does not change very much). When the power of the color copy machine 1 is turned ON, the temperature of the heat roller of the fixing device 22 or the like is measured by, for example, a thermistor, and the registration adjustment may be performed according to the measurement result as the need arises. For example, only when the measurement result is lower than an allowable temperature (60° C.), the registration adjustment may be performed at the time of warming-up.

In the first embodiment, after the power is turned ON, before the charge amount of the developer of the developing devices 14Y, 14M, 14C and 14K becomes stable, the patterns for registration are formed on the transfer belt 10 at the registration density obtained under the image formation condition A. The registration adjustment is first completed by using the formed patterns. After the power is turned ON, the charge amount of the developer becomes stable before the registration adjustment is completed. After the charge amount of the developer becomes stable, the image quality adjustment is performed. After the power is turned ON, the registration adjustment is first performed without waiting for stabilization of the charge amount of the developer. Thus, the time before the charge amount of the developer becomes stable can be effectively used. Even if the charge amount of the developer does not become stable, the patterns for registration are formed by using the calculated image formation condition A. Accordingly, at the time of the registration adjustment, there does not occur a problem due to the instability of the density of the pattern, and the high-precision registration adjustment is obtained. The waiting time of the user until the image adjustment including the image quality adjustment and the registration adjustment is completed can be shortened, and the speed of printing can be increased. By the shortening of the waiting time until the image adjustment is completed, services to the user can be improved.

Next, a second embodiment will be described. In the second embodiment, registration density when patterns for registration adjustment are written is different from that of the first embodiment. The others are constructed similarly to the first embodiment, and with respect to the same structure, the explanation is common to the first embodiment and the second embodiment. In the second embodiment, (2) the patterns are written on the transfer belt 10 by using the registration density determined based on the immediately prior density adjustment value.

After the image adjustment is completed, the color copy machine 1 performs desired printing corresponding to image data. For example, when the image adjustment is performed using the timing between sheets P during printing of the image data, the image formation condition B at the time of the image formation decided at Act 210 of FIG. 9 is made the immediately prior density adjustment value.

For example, the image quality adjustment of the color copy machine 1 is performed at the timing between the sheets P during the printing of the image data. In the second embodiment, it is not necessary to perform the operation for setting, based on the environmental characteristics and the aging characteristics, the image formation condition A under which the registration pattern is formed. In the second embodiment, when the image adjustment is started, the immediately prior density adjustment value stored in the memory 102 (image formation condition B) is used as the image formation condition A of Act 202 of FIG. 9. Patterns of the specified condition are printed on the transfer belt 10 at the immediately prior density adjustment value (image formation condition B). The interval between the printed patterns is detected. Thereafter, similarly to the first embodiment, the image adjustment is performed by Act 203, Act 204, Act 206 to Act 208, and Act 210 to Act 212. At Act 210, the image formation condition B is newly decided, and the memory 102 is written.

In the image adjustment when the power of the color copy machine 1 is turned ON, for example, the image formation condition B at the time of image formation immediately before the power of the color copy machine 1 is turned off on the preceding day is used as (2) the registration density determined based on the immediately prior density adjustment value.

In the second embodiment, similarly to the first embodiment, after the power is turned ON, the registration adjustment is completed, and then, the image quality adjustment is performed. After the power is turned ON, the registration adjustment can be first performed without waiting for stabilization of the charge amount of the developer, and the time before the charge amount of the developer becomes stable can be effectively used. Even if the charge amount of the developer does not become stable, the patterns are formed at the registration density while the immediately prior density adjustment value (image formation condition B) is made the image formation condition A. The calculation of the image formation condition A becomes unnecessary. There does not occur a problem due to instability of pattern density at the time of registration adjustment, and the registration adjustment can be performed at high precision. The waiting time until the image adjustment of performing the image quality adjustment and the registration adjustment is completed can be shortened, and the speed of printing can be increased. Services to the user can be improved by shortening of the waiting time until the completion of the image adjustment.

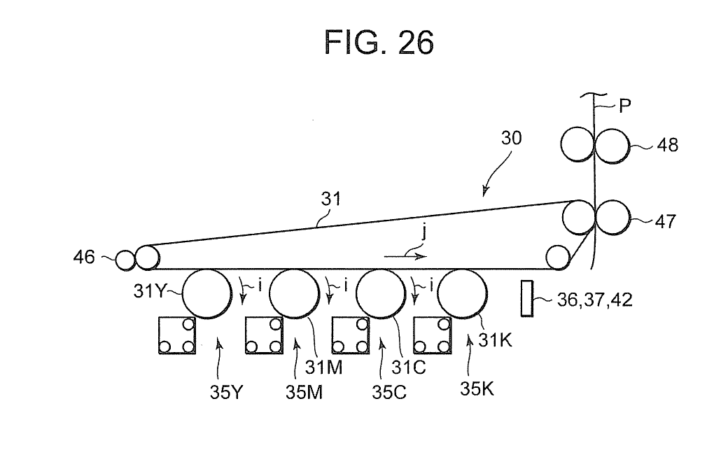

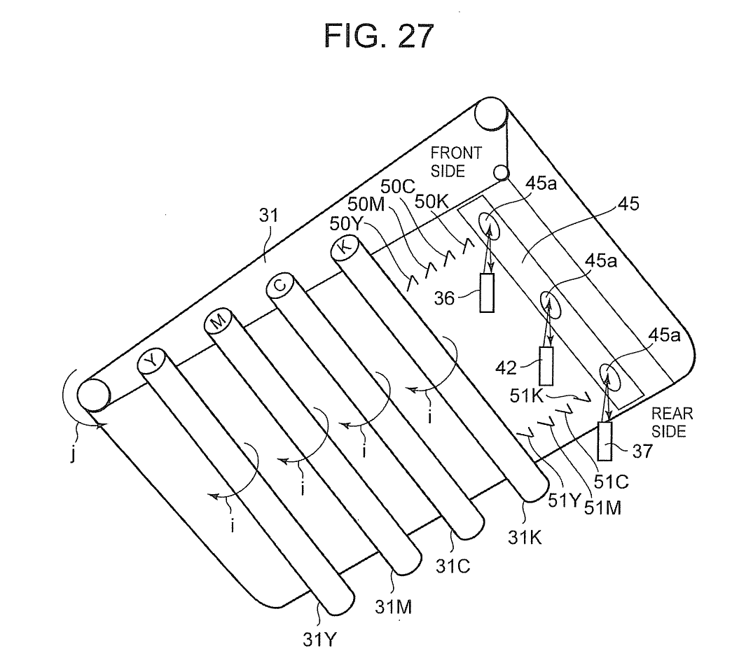

The invention is not limited to the above embodiment, but various modifications can be made within the scope of the invention. For example, the structure of the image forming apparatus is not limited. In the case of the image forming apparatus of the train-of-four tandem system, the apparatus may be such that color printing is performed using an intermediate transfer belt. FIG. 26 and FIG. 27 show a main part of a color copy machine 30 of a first modified example. The color copy machine 30 uses an intermediate transfer belt 31 as an intermediate transfer medium. Four sets of image forming stations 35Y, 35M, 35C and 35K including photoconductive drums 31Y, 31M, 31C and 31K of yellow (Y), magenta (M), cyan (C) and black (K) are disposed in parallel along the lower side of the intermediate transfer belt 31. First and second pattern sensors 36 and 37 and a density sensor 42 are provided downstream of the image forming station 31K of black (K) in the intermediate transfer belt rotating in an arrow j direction. A detection position of the intermediate transfer belt 31 by the first and the second pattern sensors 36 and 37 and the density sensor 42 is covered with a shutter 45 having openings 45a.

In the first modified example, at the time of image adjustment, front side patterns 50Y, 50M, 50C and 50K, rear side patterns 51Y, 51M, 51C and 51K, and patches 134Y, 134M, 134C and 134K of respective color components are printed on the intermediate transfer belt 31. The patterns and the patches are respectively read through the openings 45a of the shutter 45, and the image adjustment is performed. After the image adjustment, an intermediate transfer belt cleaner 46 removes the patterns and the patches. At the time of an image formation mode, toner images on the photoconductive drums 31Y, 31M, 31C and 31K rotating in an arrow i direction are primarily transferred to the intermediate transfer belt 31. The toner images on the intermediate transfer belt 31 are collectively secondarily transferred to a sheet P at the position of a secondary transfer roller 47. The toner image on the sheet P is fixed by a fixing device 48, and the fixed toner image is obtained on the sheet P.

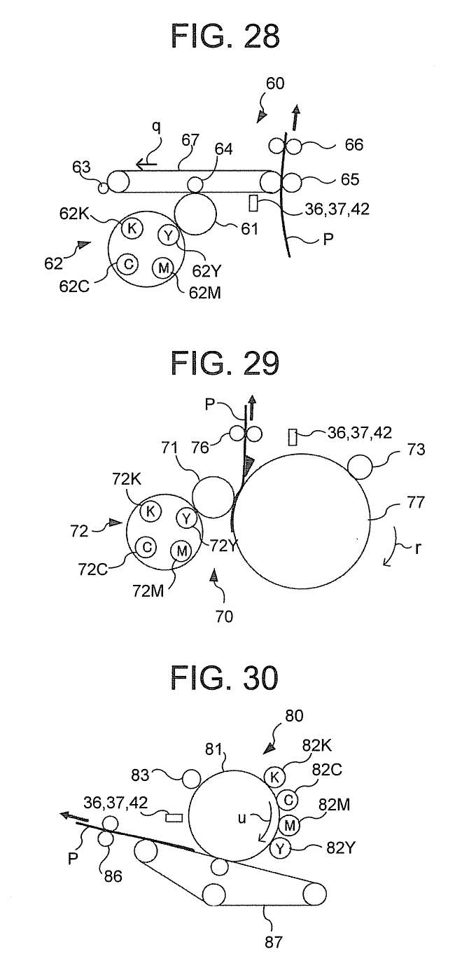

The image forming apparatus may be an image forming apparatus of four-rotation intermediate transfer system. FIG. 28 shows a main part of a color copy machine 60 of a second modified example of the four-rotation intermediate transfer system. The color copy machine 60 includes one photoconductive drum 61 and an intermediate transfer belt 67 as an intermediate transfer medium. The color copy machine 60 includes a revolver developing unit 62 rotating and holding developing devices 62Y, 62M, 62C and 62K of yellow (Y), magenta (M), cyan (C) and black (K). First and second pattern sensors 36 and 37 and a density sensor 42 are provided around the intermediate transfer belt 67 rotating in an arrow q direction and downstream of the photoconductive drum 61.

In the second modified example, at the time of image adjustment, patterns and patches formed on the intermediate transfer belt 67 are read, and the image adjustment is performed. After the image adjustment, an intermediate transfer belt cleaner 63 removes the patterns and the patches. At the time of an image formation mode, for example, at the first rotation of the photoconductive drum 61, an yellow (Y) toner image is formed on the photoconductive drum 61. The yellow (Y) toner image on the photoconductive drum 61 is primarily transferred to the intermediate transfer belt 67 by a primary transfer roller 64. At the second rotation of the photoconductive drum 61, a magenta (M) toner image is formed on the photoconductive drum 61. The magenta (M) toner image on the photoconductive drum 61 is superimposed on the yellow (Y) toner image on the intermediate transfer belt 67 and is primarily transferred by the primary transfer roller 64. The photoconductive drum 61 is rotated four times, and a color toner image in which the yellow (Y), magenta (M), cyan (C) and black (K) toner images are superimposed on one another is formed on the intermediate transfer belt 67. The color toner image on the intermediate transfer belt 67 is collectively secondarily transferred to a sheet P at a position of a secondary transfer roller 65. The toner image on the sheet P is fixed by a fixing device 66, and the fixed toner image is obtained on the sheet P.

The image forming apparatus may be an image forming apparatus of multi-transfer (transfer drum) system. FIG. 29 shows a main part of a color copy machine 70 of a third modified example of the multi-transfer (transfer drum) system. The color copy machine 70 includes one photoconductive drum 71 and a transfer drum 77 as an intermediate transfer medium. The color copy machine 70 includes a revolver developing unit 72 rotating and holding developing devices 72Y, 72M, 72C and 72K of yellow (Y), magenta (M), cyan (C) and black (K). First and second pattern sensors 36 and 37 and a density sensor 42 are provided around the transfer drum 77 rotating in an arrow r direction and downstream of the photoconductive drum 71.

In the third modified example, at the time of image adjustment, patterns and patches formed on the transfer drum 77 are respectively read, and the image adjustment is performed. After the image adjustment, a transfer drum cleaner 73 removes the patterns and the patches. At the time of an image formation mode, for example, at the first rotation of the photoconductive drum 71, an yellow (Y) toner image is formed on the photoconductive drum 71. The yellow (Y) toner image on the photoconductive drum 71 is primarily transferred to the transfer drum 77. At the second rotation of the photoconductive drum 71, a magenta (M) toner image is formed on the photoconductive drum 71. The magenta (M) toner image on the photoconductive drum 71 is superimposed on the yellow (Y) toner image on the transfer drum 77 and is primarily transferred. The photoconductive drum 71 is rotated four times, and a color toner image in which yellow (Y), magenta (M), cyan (C) and black (K) toner images are superimposed on one another is formed on the transfer drum 77. The color toner image on the transfer drum 77 is collectively secondarily transferred to the sheet P traveling between the photoconductive drum 71 and the transfer drum 77. The toner image on the sheet P is fixed by a fixing device 76, and the fixed toner image is obtained on the sheet P.

The image forming apparatus may be an image forming apparatus of collective transfer (multi-development) system. FIG. 30 shows a main part of a color copy machine 80 of a fourth modified example of the collective transfer (multi-development) system. The color copy machine 80 includes one photoconductive drum 81 and a transfer belt 87. The color copy machine 80 includes developing devices 82Y, 82M, 82C and 82K of yellow (Y), magenta (M), cyan (C) and black (K) around the photoconductive drum 81. First and second pattern sensors 36 and 37 and a density sensor 42 are provided around the photoconductive drum 81 rotating in an arrow u direction and downstream of the transfer belt 87.

In the fourth modified example, at the time of image adjustment, patterns and patches formed on the photoconductive drum 81 are read, and the image adjustment is performed. After the image adjustment, a photoconductive cleaner 83 removes the patterns and the patches. At the time of an image formation mode, for example, at the first rotation of the photoconductive drum 81, an yellow (Y) toner image is formed on the photoconductive drum 81. At the second rotation of the photoconductive drum 81, a magenta (M) toner image is formed to be superimposed on the yellow (Y) toner image on the photoconductive drum 81. The photoconductive drum 81 is rotated four times, and a color toner image in which yellow (Y), magenta (M), cyan (C) and black (K) toner images are superimposed on one another is formed on the photoconductive drum 81. The color toner image on the photoconductive drum 81 is collectively primarily transferred to the sheet P traveling on the transfer belt 87. The toner image on the sheet P is fixed by a fixing device 86, and the fixed toner image is obtained on the sheet P.

The pattern shape or the pattern interval when the registration adjustment is performed is not limited. The pattern of dots of the halftone patch when the image quality adjustment is performed is not limited.

What is claimed is:

1. An image forming apparatus comprising:
a latent image forming member to form an electrostatic latent image on each of a plurality of image carriers;
a plurality of developing members to develop the electrostatic latent images formed on the plurality of image carriers and to form a plurality of toner images;
a transfer member to transfer the plurality of toner images formed on the plurality of image carriers; and
a control member that detects positions of the plurality of toner images transferred to a transfer medium, causes a registration mode of performing registration adjustment of the respective toner images and an image quality maintaining mode of performing image quality adjustment of the respective toner images to be selectively performed, and performs the registration mode before the image quality maintaining mode.

2. The apparatus of claim 1, wherein an image formation condition for forming the toner images necessary for the registration mode is different from an image formation condition of the image formation mode.

3. The apparatus of claim 2, wherein the image formation condition for forming the toner images necessary for the registration mode is determined using characteristics of the plurality of developing members.

4. The apparatus of claim 3, wherein the characteristics of the plurality of developing members include an environmental characteristic and an aging characteristic.

5. The apparatus of claim 2, wherein the image formation condition for forming the toner images necessary for the registration mode is determined using characteristics of the image carriers and a characteristic of the latent image forming member.

6. The apparatus of claim 2, wherein the image formation condition for forming the toner images necessary for the registration mode is determined using an assumed density adjustment value.

7. The apparatus of claim 6, wherein the assumed density adjustment value is determined based on a prior density adjustment value closest to a time of a start of the registration mode.

8. The apparatus of claim 7, wherein the prior density adjustment value is a density adjustment value when the image forming apparatus is turned OFF.

9. The apparatus of claim 1, wherein the transfer member includes an intermediate transfer medium to which the formed toner images formed on the image carriers at a time of an image formation mode are primarily transferred and which secondarily transfers the primarily transferred formed toner images to a recording medium.

10. The apparatus of claim 1, wherein the transfer member primarily transfers the formed toner images formed on the image carriers at a time of an image formation mode to a recording medium.

11. An image forming method comprising:
forming a plurality of pattern toner images for registration;
performing registration adjustment using the plurality of pattern toner images; and
performing image quality adjustment after the registration adjustment.

12. The method of claim 11, wherein a condition for forming the plurality of pattern toner images is different from an image formation condition of an image formation mode.

13. The method of claim 12, wherein the condition for forming the plurality of pattern toner images is determined using characteristics of a plurality of developing members used for formation of the plurality of pattern toner images.

14. The method of claim 13, wherein the characteristics of the plurality of developing members include an environmental characteristic and an aging characteristic.

15. The method of claim 11, wherein a condition for forming the plurality of pattern toner images is determined using characteristics of image carriers to hold the plurality of pattern toner images and a characteristic of a latent image forming member to form electrostatic latent images on the image carriers.

16. The method of claim 11, wherein an assumed density adjustment value is used as a condition for forming the plurality of pattern toner images.

17. An image forming method comprising:
performing registration adjustment using a plurality of pattern toner images;
performing image quality adjustment using a plurality of image quality toner images; and
performing, after the registration adjustment and the image quality adjustment, an image formation mode under an image formation condition different from an image formation condition for forming the pattern toner images.

18. The method of claim 17, wherein the image formation condition for forming the plurality of pattern toner images is determined using characteristics of a plurality of developing members used for formation of the plurality of pattern toner images.

19. The method of claim 17, wherein the image formation condition for forming the plurality of pattern toner images is determined using characteristics of image carriers to hold the plurality of pattern toner images and a characteristic of a latent image forming member to form electrostatic latent images on the image carriers.

20. The method of claim 17, wherein an assumed density adjustment value is used as the image formation condition for forming the plurality of pattern toner images.
